(19) United States
(12) Patent Application Publication
(10) Pub. No.: US 2016/0214373 A1
(43) Pub. Date: Jul. 28, 2016

(54) METHOD AND SYSTEM FOR APPLYING INFORMATION ON FOOD PACKAGING

(71) Applicant: TEN Media, LLC dba TEN Ag Tech Co., San Juan Capistrano, CA (US)

(72) Inventors: Jonathan R. Phillips, San Juan Capistrano, CA (US); Richard C. Blackburn, Santa Ana, CA (US)

(73) Assignee: TEN Media, LLC dba TEN Ag Tech Co., San Juan Capistrano, CA (US)

(21) Appl. No.: 15/005,997

(22) Filed: Jan. 25, 2016

Related U.S. Application Data
(60) Provisional application No. 62/107,439, filed on Jan. 25, 2015.
(60) Provisional application No. 62/107,530, filed on Jan. 26, 2015.

(51) Int. Cl. B41F 17/00; G06K 15/02

(52) U.S. Cl. CPC B41F 17/00; G06K 15/02

(57) ABSTRACT

The present disclosure includes a method and system for applying markings on a food product package in such a manner to form a permanent marking thereon. The markings may include text, graphics, images, advertisements or other promotional material, freshness information, traceability data, other types of indicia, and any combination thereof. The markings are applied by any suitable marking device known in the art, such as laser-based or ink-based technologies. The method preferably forms the markings on the food product package while such package moves through a predetermined region of a food processing system.

### CROSS-REFERENCE TO RELATED APPLICATIONS

This application claims the benefit of U.S. Provisional Application No. 62/107,439 filed on Jan. 25, 2015 and U.S. Provisional Application No. 62/107,530 filed on Jan. 26, 2015, the contents of which are incorporated herein by reference in their entirety.

### BACKGROUND

The disclosure relates generally to the field of food product processing, and more particularly methods and systems for marking information and other relevant data on food product packaging. The disclosure further relates to methods and systems for monitoring and managing food product processing facilities. While reference is made herein to eggs in particular, it should be understood that this disclosure is directed to all food product packaging in which images and/or data may be applied thereon.

In the egg packing industry, eggs typically undergo a great deal of processing before they are ready to be sold to the consuming public. In many circumstances, for example, eggs pass through several processing stations where they are washed, candled, weighed, graded, and packed into packages (e.g., cartons, crates, or other commercially distributed containers). Examples of such processing stations and mechanisms for conveying eggs from station to station are described, for instance, in the following U.S. patents assigned to Diamond Automations, Inc. (U.S. Pat. Nos. 4,189,898; 4,195,736; 4,505,373; 4,519,494; 4,519,505: 4,569,444; 4,750,316; 5,321,491; and 6,056,341) and TEN Media LLC (U.S. Pat. No. 8,455,030), which are incorporated herein by reference in their entirety. As a reference, it is not uncommon for a facility in which these stations operate to output about one million eggs in a single day. Accordingly, to be commercially acceptable, the throughput of the stations needs to be quite high, with some stations typically processing on the order of 20,000 eggs per hour.

The egg packing industry uses devices known as “packers” to pack the eggs into the packages. Typically, a packer includes a conveyor (e.g., a belt conveyor, roller conveyor, chain conveyor, etc.) that moves empty packages through an egg loading section (where the eggs are loaded into the egg loading section from above) and then moves the filled packages to a package closing section that is responsible for closing the lids of the packages. The eggs may be supplied to the egg packer via a grader system.

An egg packing process that uses “packers,” typically uses bulk belts to bring eggs from a bulk supply location. The eggs are cleaned or disinfected, in some instances using UV light while clamped to transport chains, and in some instances through immersion in sanitizing wash water. The eggs are then inspected either electronically or manually, they are weighed to establish size, inspected for cracks using ultrasonic inspection and loaded into a chain driven carriage mechanism (“Transfer Loader”). The egg is then normally transported to one of a plurality of packing machines by the aforementioned carriage mechanism. The particular packing machine to which any individual egg may be transported is determined by a computer. This process or elements thereof up to, but not including the packing machine, constitute grading (“Grading” and the “Grader”). The carriage mechanism typically consists of one or a plurality of chains, running the length of the Grader past all the packing machines in the horizontal plane (“Grader Chains”). The packing machines are usually configured with an egg flow perpendicular to the Grader Chain in the horizontal plane.

Recently in the egg packing industry, there has been an effort to mark the eggs produced with a freshness date, traceability code, and advertisements—see U.S. Patent Application Publication No. US 2014/0085397, titled “Methods And Apparatus For Storing And Retrieving Information Relating to Edible Objects,” to B. E. Parker, published Mar. 27, 2014, which is hereby incorporated by reference in its entirety

The egg industry uses marking devices to print Size, Grade and Date information together with other information or images and logos (“Data”) on to the surface of an egg shell of a fresh egg travelling through an egg grading machine. The marking devices are traditionally placed in a location on the production line that is responsible for grading the eggs and the site for such installation is chosen to minimize the number of marking devices required for a given installation. Marking devices have typically been installed on the Grader Chains as near to the Transfer Loader as practical, and typically (although not always), prior to all the packing machines to which almost all eggs are later diverted.

Unfortunately, the marking operation requires that the eggs in the egg packages be exposed to the egg marking system, the egg cartons remain in an open configuration when they are ejected from the egg marking system. These cartons must be closed before they can be shipped to resellers and should be closed as part of the normal process of moving the cartons through the moving conveyor system of the packer. Due to the variety of egg cartons used in the industry, there are multiple methods egg carton makers use to lock their cartons in a closed position. Additionally, even without the need to mark the eggs, the cartons should be closed after the eggs have been packed into the cartons by the packer.

Once closed, the egg cartons may be marked by a printer that is located on the packer. Unfortunately, existing technologies produce low-quality marks on the egg cartons, such marks are not usually readily updated during the production process without production downtime. Additionally, usually a significant proportion of the marks on cartons are partially or wholly illegible.

As such, there is a need in the art for a system and method to improve the quality of the printing process used for printing egg cartons in the egg packing industry.

### BRIEF SUMMARY

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with embodiments herein, the present disclosure includes a method and system for applying markings on a food product packaging in such a manner to form a permanent marking thereon. The markings may include text, graphics, images, advertisements or other promotional material, freshness information, traceability data, other types of indicia, and any combination thereof. The markings are applied by any suitable marking device known in the art, such as laser-based or ink-based technologies. The method preferably forms the markings on the food product packaging while such package moves through a predetermined region of a food processing system.

A preferred embodiment includes a system for applying markings on egg cartons that is operable in association with an egg-handling machine that performs washing, candling, grading, and packing of eggs. The system comprises a marking device located in proximity to the egg-handling machine, so that the marking device can form the markings. In a preferred embodiment, the egg carton has a marking applied thereon. The markings may be formed by a generally stationary marking device as the egg carton is transported past the marking device.

In some embodiments, the present disclosure provides a method and system for applying markings on food product packaging, comprising conveying the food product package to a marking system having at least one marking device configured to apply markings thereon. The markings may include text, graphics, images, advertisements or other promotional material, freshness information, traceability data, other types of indicia, and any combination thereof. In a preferred embodiment, the food product package is an egg carton. In a preferred embodiment, the egg carton is closed prior to marking thereon.

Still other advantages, aspects and features of the subject disclosure will become readily apparent to those skilled in the art from the following description wherein there is shown and described a preferred embodiment of the present disclosure, simply by way of illustration of one of the best modes best suited to carry out the subject disclosure As it will be realized, the present disclosure is capable of other different embodiments and its several details are capable of modifications in various obvious aspects all without departing from the scope herein. Accordingly, the drawings and descriptions will be regarded as illustrative in nature and not as restrictive.

### BRIEF DESCRIPTION OF THE DRAWINGS

The accompanying drawings incorporated herein and forming a part of the specification illustrate the example embodiments.

FIG. 1 is a diagrammatic view depicting an embodiment of an egg packing system.

FIG. 2 is a diagrammatic view depicting another embodiment of an egg packing system.

FIG. 3A is a perspective view of an example of an embodiment of a carton marking system for marking information on egg cartons in combination with a carton lid closing system in accordance with the present disclosure.

FIG. 3B is a front view of an example of an embodiment of a carton marking system for marking information on egg cartons in combination with a carton lid closing system in accordance with the present disclosure.

FIG. 3C is a side view of an example of an embodiment of a carton marking system for marking information on egg cartons in combination with a carton lid closing system in accordance with the present disclosure.

FIG. 3D is a top view of an example of an embodiment of a carton marking system for marking information on egg cartons in combination with a carton lid closing system in accordance with the present disclosure.

FIG. 4A is a front view of an example of an embodiment of a carton marking system for marking information on egg cartons in combination with a carton lid closing system in accordance with the present disclosure.

FIG. 4B is a side view of an example of an embodiment of a carton marking system for marking information on egg cartons in combination with a carton lid closing system in accordance with the present disclosure.

FIG. 5 illustrates an example of a computer system 500 upon which an example embodiment may be implemented

FIG. 6 is a diagram depicting an egg carton bearing markings using method and apparatus embodiments of the present disclosure.

FIG. 7 is a diagram depicting an egg carton bearing markings using method and apparatus embodiments of the present disclosure.

FIG. 8 is a diagram depicting an egg carton bearing markings using method and apparatus embodiments of the present disclosure.

### DETAILED DESCRIPTION OF THE PREFERRED EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

In general, the embodiments herein provide methods and systems for marking information on food product packaging. Embodiments of the present disclosure are directed to an apparatus as well as a method for marking food product packages as they pass through a marking station, with the marking being carried out by marking devices that are designed and configured to render text and graphic representations as the food product packages pass through the marking station. While reference is made herein to eggs and egg cartons in particular, it should be understood that this disclosure is directed to all food products and associated packaging in which a mark may be applied thereon. In the example embodiment, there is provided a method and system for applying markings on an egg carton by a marking device to form a permanent marking. However, it is to be appreciated that the embodiments of the claims herein are not limited in any way to the example embodiment, but rather are to be interpreted to cover applying markings to other suitable food product packaging.

It is further understood that the preferred embodiment for applying a marking on egg cartons uses ink-based technologies and/or laser-based technologies. However, it is to be appreciated that the embodiments contained herein are not limited to the preferred embodiments, but rather are to be interpreted to cover applying markings by any suitable marking device or system.

In a preferred embodiment, an ink-based marking device is placed in proximity of an egg carton and directs ink toward the egg carton. Suitable ink-based marking systems include non-contact systems that do not require direct contact of the printing system with the egg carton, such as a continuous inkjet printing system (“CIJ”). The system may be mounted on the Packer and may traverse across the egg cartons, applying markings thereon. In alternate embodiments, the printer may be stationary and the carton is moved past the printer as it moves on a conveyor through the egg processing system. The CIJ printing system could include a single-jet CIJ printer, a dual-jet CIJ printer, or a Binary Array type of CIJ printer.

Other embodiments of inkjet systems may use a ‘drop-on-demand’ technology, which has the potential for higher-resolution marks, and/or marks containing more content, as well as being lower cost, and less maintenance-intensive, than other inkjet technologies. This latter system configuration may use ink cartridges (as opposed to a large reservoir and associated pumps, valves, etc) and has a good potential for creating high-quality desirable sponsored images, since it offers significantly higher resolution than the traditional CIJ inkjet options noted above. Suitable drop-on-demand inkjet technologies include Thermal Inkjet (TIJ), Piezo-electric Inkjet, and MEMS-based Inkjet.

In another embodiment of the present disclosure, a radiant energy source in proximity of an egg carton directs radiant energy toward the egg carton. Radiant energy source desirably includes a laser such as a CO₂ gas laser adapted to provide light projected at the surface of the egg carton. In a preferred embodiment, the beam may be turned on and off so as to provide a series of pulses. During this pulsed actuation, the beam is swept across those areas of the egg carton, which are to be marked. The sweeping motion may be performed in any manner which will provide the desired relative motion of the beam and the egg carton. Since the preferred embodiments will operate in association with an egg-handling machine which moves egg cartons at an extremely rapid speed, the beam must be rapidly moved to produce the desired indicia and also may compensate for the speed of movement of the egg cartons past the laser apparatus, which is preferably stationary. For example, the radiant energy source may include a beam-sweeping unit incorporating conventional optical elements such as movable or variable lenses, mirrors or prisms adapted to deflect the beam and to vary the deflection with time. Suitable radiant energy sources include, but are not limited to, Sealed CO₂ Gas Lasers, Slow-flow CO₂ Gas Lasers, TEA CO₂ Mask Lasers, CO₂ Gas Lasers, UV Gas Lasers, solid-state visible light lasers, and Mid-IR Solid State Lasers. In other embodiments, the radiant energy source may be also be a YAG-type and/or fiber laser system, and may be coupled with a frequency multiplying optical element.

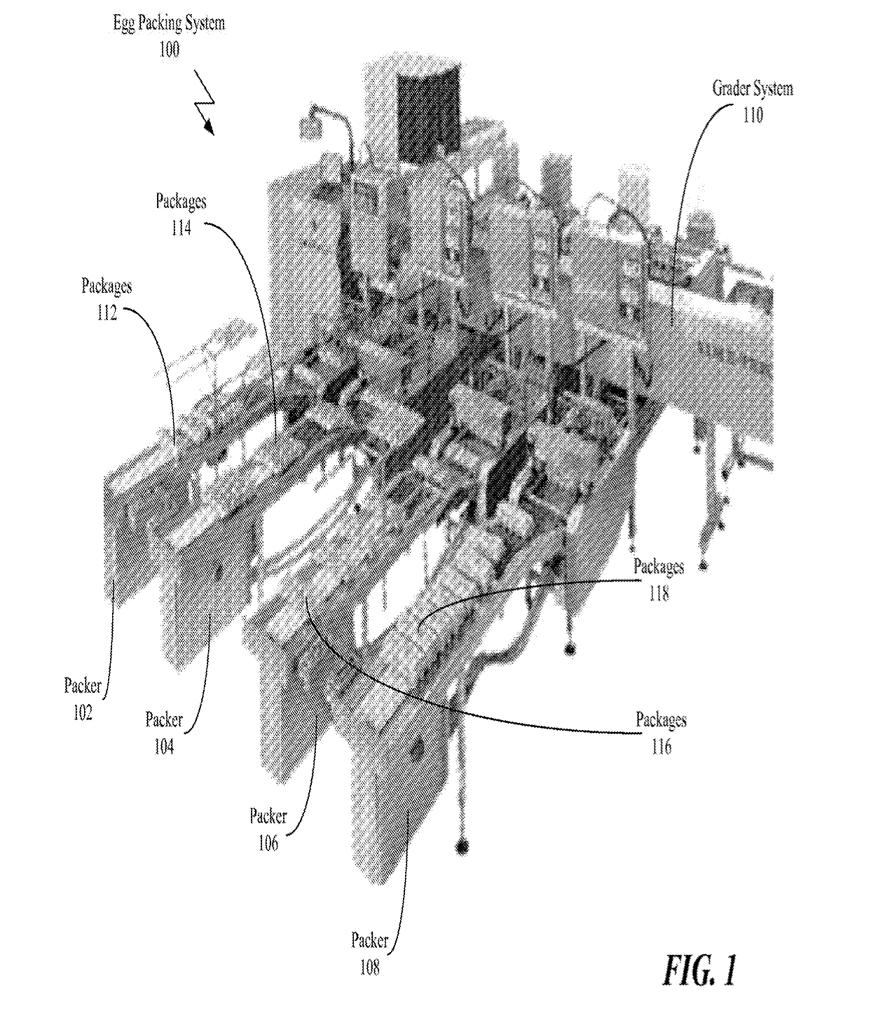

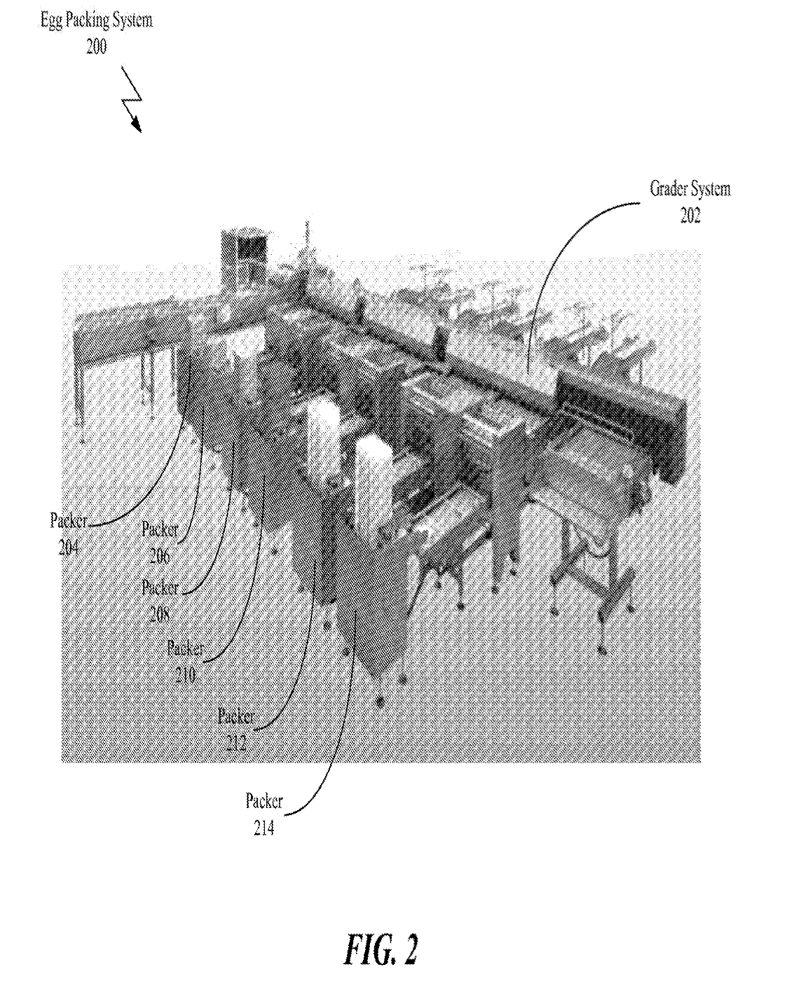

FIG. 1 illustrates an egg packing system 100 having a plurality of packers 102, 104, 106, and 108, and a grader system 110 that passes the eggs to the packers which pack the eggs into packages or cartons 112, 114, 116, and 118. FIG. 2 illustrates another embodiment of an egg packing system 200 that includes a grader system 202 and a plurality of packers 204, 206, 208, 210, 212, and 214. The eggs as packaged in the cartons are then transported, preferably by a conveyor, to a printing assembly (not shown) for applying markings to the eggs. In order to apply the markings to the eggs, the egg cartons are in an open configuration. Once the markings have been applied to the eggs in the carton, the carton must be closed before further processing thereof, such as before marking on such carton.

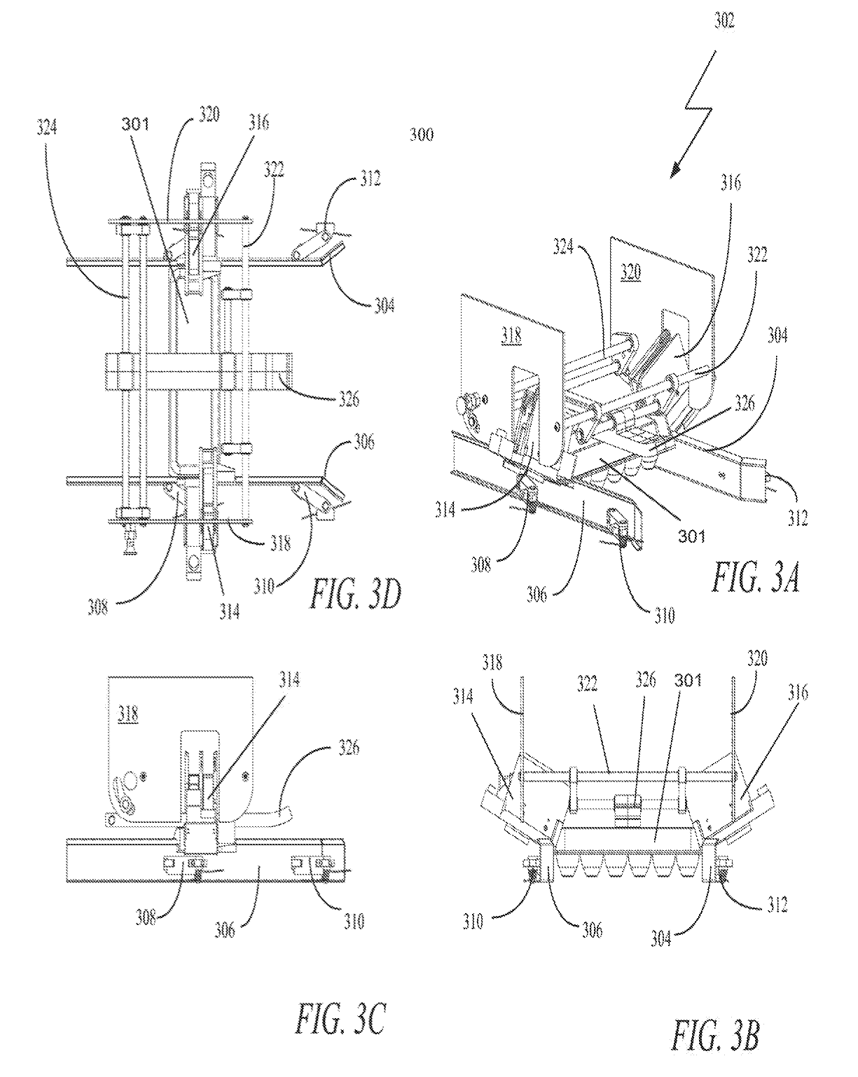

FIGS. 3A through 3D illustrate an example embodiment of a carton marking system 300 for marking information on egg cartons in combination with a carton lid closing system Once the eggs have been packed into the egg carton (also known as an egg container) 301, the lid of the egg carton needs to be closed prior to marking at the carton marking station. In order to protect the eggs contained in the egg carton, a carton lid closer 302 is shown in FIGS. 3A through 3D. In a preferred embodiment, the carton lid closer 302 employs a progressive closing action mechanism, rather than an instantaneous closing action, in order to provide additional safeguards against breakage of eggs.

While the carton lid closing system 302 is shown as part of the carton marking system 300 in FIGS. 3A through 3D, it is to be understood that in some embodiments, the carton lid closing system may be separate from the carton marking system. In some embodiments, the carton lid closing system may precede the carton marking system. This allows independent behavior and timing between the carton lid closing system and the carton marking system.

Turning to the carton marking system 300, the carton marking system may include two parallel-motion rails 304 and 306 with spring loading mechanisms 308, 310, and 312 that may provide consistent pressure on the sides of egg carton 301. In this example, the parallel-motion rails 304 and 306 allow the egg carton 301 to be successfully processed even when the egg carton 301 passes significantly off-center through the carton marking station. In one embodiment, the parallel-motion rails 304 and 306 may be configured to self-adjust for different types of egg cartons or egg carton dimensions, such as jumbo, double-six cartons, and the like. Additionally, the parallel-motion rails 304 and 306 on both sides may self-adjust to accommodate manufacturing tolerances on egg cartons between batches, manufacturers, and the like.

In some embodiments, at least one marking assembly is mounted so that the egg cartons 301 pass by the at least one marking assembly once the egg cartons have been closed. Any suitable ink-based marking device or laser-based marking device may be used for marking on the egg cartons. As shown in FIGS. 3A through 3D, two thermal inkjet cartridges (“TIJ”) 314 and 316, or other drop-on demand print technology as discussed above) are shown located along two removable plates 318 and 320. The two removable plates 318 and 320 are connected to a pair of closing mechanism shafts 322 and 324. The closing mechanisms shafts 322 and 324 are connected to a carton lid hold-down bar (or bars) 326. The carton lid hold-down bar 326 may include a carton lid closing heel (not shown) to more easily close lids which are unevenly shaped. The self-adjusting parallel-motion rails 304 and 306 may provide a consistent throw distance for the TIJs 314 and 316, for optimum print quality on egg carton 301. The self-adjusting parallel-motion rails 304 and 306 may also have tapered lead-in, to adjust to the width and off-center position of the egg cartons as they enter the carton marking system 300.

In this example, the carton lid hold-down bars 326 are provided to run over the top of the egg carton 301 as it moves through the carton marking system 300. In this fashion, the carton lid hold-down bars 326 may ensure that the egg carton 301 remains closed during the marking process. The carton lid hold-down bars 326 may also be latched in a retracted (i.e., “up”) position to allow non- closed egg carton 301 types to pass through the carton marking system without contact or damage to the egg carton 301 or eggs. The carton lid hold-down bars 326 provide consistent pressure/resistance to motion, keeping the egg carton 301 speed consistent with the speed of cleats in the moving apparatus that moves the egg carton 301 through the carton lid closer 302 and marking system 300, providing improved printing conditions for the TIJs 314 and 316. The two removable plates 318 and 320 may include the hold-down bars 326 and the associated control and adjustment mechanisms, and may be completely removable to allow cleaning and access. In some embodiments, the hold-down bars 326 and the side rails 304 and 306 are shorter than the gap between successive cartons on the conveyor. This provides that a tall carton, mis-aligned carton, improperly closed carton, and the like cannot force up the bars 326 or force out the rails 304 and 306, either of which could impact the quality of printing on the preceding or following carton that was not oversized or out of position.

In this example, printing after the egg carton 301 is closed may improve the ink utilization in the TIJs 314 and 316. The TIJs 314 and 316 may be arranged in a slightly downwards-printing direction angle (the reservoir within the cartridge drains down towards the nozzles). The angle of the TIJs 314 and 316 relative to the egg cartons 301 may be optimized, designed, or tailored for multiple carton designs, maintaining throw distance within tolerances even on non-parallel carton lid ends. A local protective metal or plastic ramp before the TIJs 314 and 316 may protect the TIJs 314 and 316 from damage caused by incorrectly formed or incorrectly closed egg cartons. The protective ramp also can provide the throw distance control if the egg carton design means that the parallel-motion rails 304 and 306 are not touching the egg carton.

In a preferred embodiment, the protective ramp mounted to the TIJs 314 and 316 may include a protected recess to allow printing within 0.010 inches or greater of the egg carton surface while preventing smudging of the ink and any build-up of debris or egg carton fibers that could impact the printing quality. Egg debris and carton dust pose a particular problem for high-resolution drop-on-demand printers, since the individual nozzles can become clogged with the dust or debris, degrading print quality, sometimes to a level where the print content cannot be unambiguously determined.

In a preferred embodiment, the egg carton 301 passes along on a conveyor belt (or other movement means) through the combined carton marking system and carton closing system. In a preferred embodiment, the egg carton moves at speed that allows for legibly marking the information thereon. In one embodiment, the egg cartons travel at a constant speed, wherein such constant speed is achieved when the complete egg carton 301 is processed in a single motion, without an intermittent start-stop motion. The advantage of printing during constant speed motion is that an encoder is not required. The encoder would be configured in one embodiment for measuring instantaneous speed of the carton. Other embodiments may include an encoder or other speed measurement device to determine the speed of the conveyor or carton, and adjust the printer device accordingly.

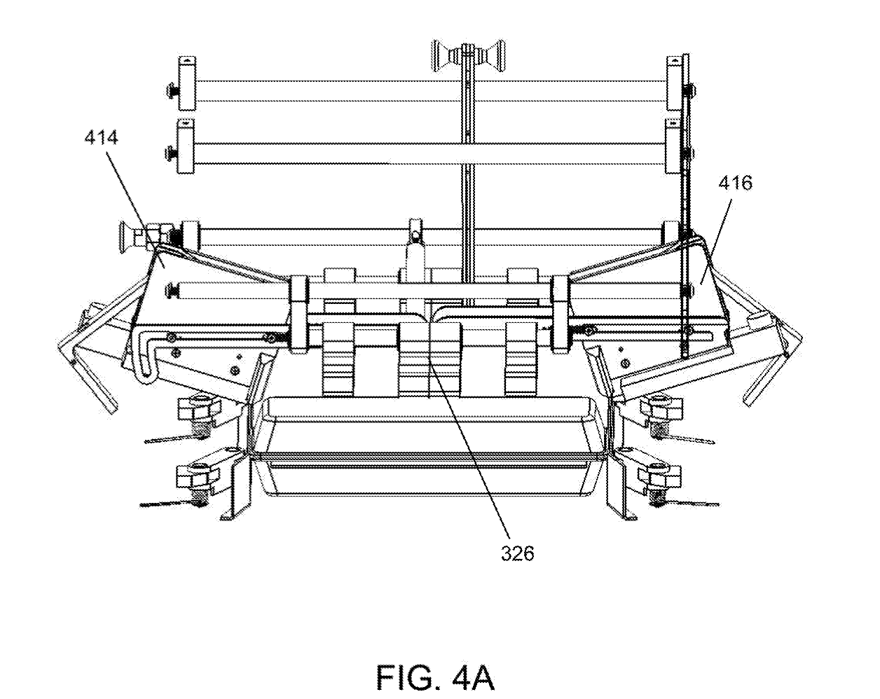

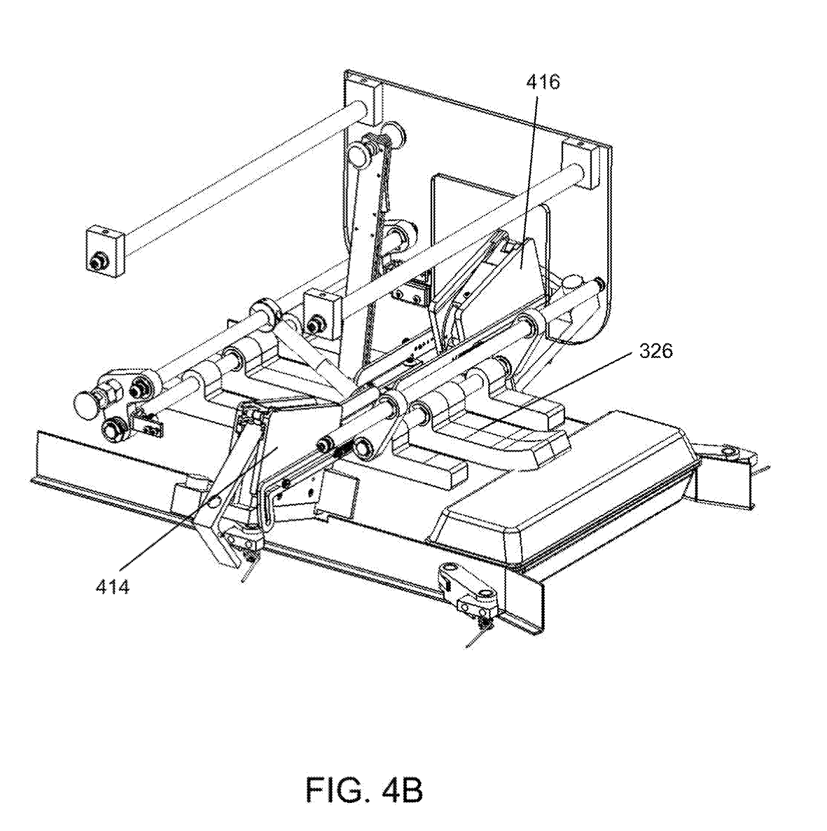

In another preferred embodiment, printing devices 414 and 416 may be mounted to the hold down bars 326, as shown in FIGS. 4A and 4B. This then automatically adjusts the height of the printing assembly 400 to match the height of the cartons passing through the system. The protective ramps control the throw distance to the surface of the carton. Springs in the mechanism may provide consistent force pressing the ramps to the surface of the carton. Other constant-force devices may be used. In this embodiment there is no direct connection between the side rails 304 and 306 and the printing devices 414 and 416. In this embodiment the side rails preferably are configured to center the carton so that the protective ramps smoothly contact the carton upon entry of the carton to the printing location (non-centered cartons can jam into the printheads). This embodiment more readily prints consistently when many different designs of carton are being processed, such designs varying significantly in overall height.

It is be understood that the at least one marking assembly may be positioned at any suitable location for marking on the egg cartons and that the location referenced herein is only for example purposes. Further, the carton marking system may include multiple marking assemblies and such marking assemblies may be configured or positioned as required for effective processing.

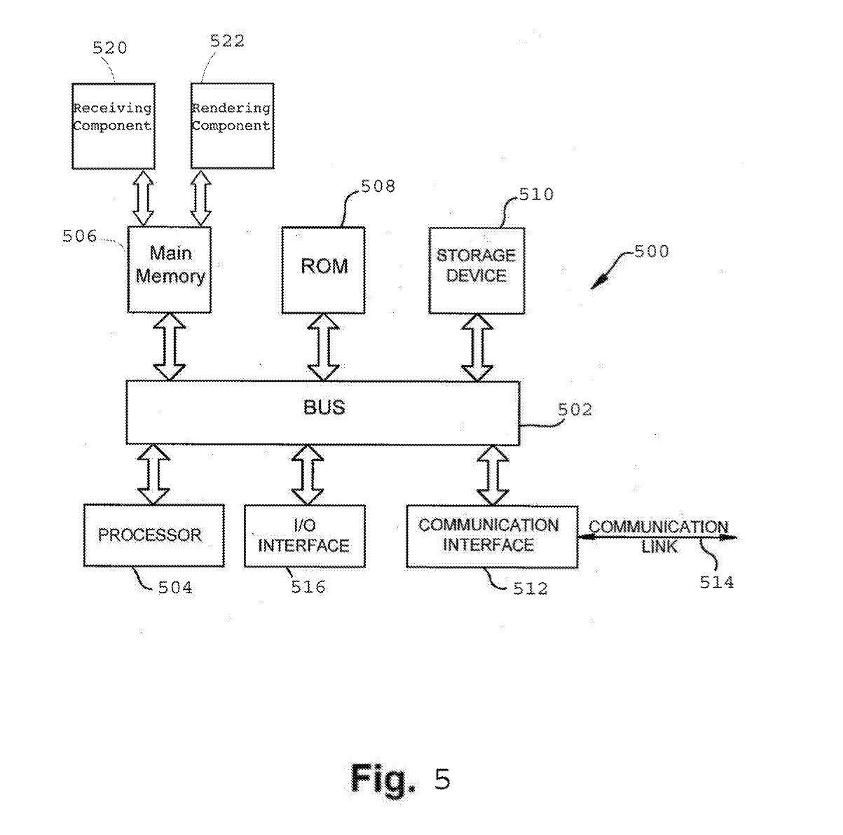

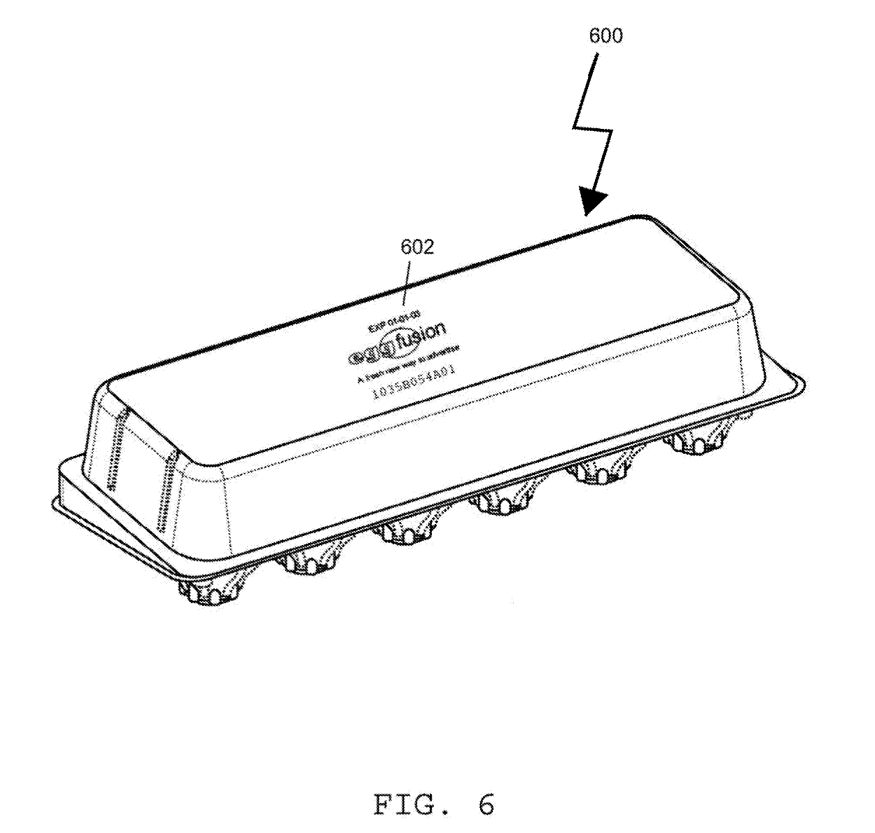

FIG. 5 illustrates an example of a computer system 500 upon which an example embodiment may be implemented. Computer system 500 is suitable for implementing the functionality of any embodiment of the carton marking system 300 described herein in FIGS. 3 through 4.

Computer system 500 includes a bus 502 or other communication mechanism for communicating information and a processor 504 coupled with bus 502 for processing information. Computer system 500 also includes a main memory 506, such as random access memory (RAM) or other dynamic storage device coupled to bus 502 for storing information and instructions to be executed by processor 504. Main memory 506 also may be used for storing a temporary variable or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk, optical disk, SD memory and/or flash storage, is provided and coupled to bus 502 for storing information and instructions.

An aspect of the example embodiment is related to the use of computer system 500 to implement the method and system for applying markings to food product packaging. According to an example embodiment, applying markings thereon are provided by computer system 500 in response to processor 504 executing one or more sequences of one or more instructions contained in main memory 506. Such instructions may be read into main memory 506 from another computer-readable medium, such as storage device 510. Execution of the sequence of instructions contained in main memory 506 causes processor 504 to perform the process steps described herein. One or more processors in a multi-processing arrangement may also be employed to execute the sequences of instructions contained in main memory 506. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 504 for execution. Such a medium may take many forms, including but not limited to non-volatile media, and volatile media. Non-volatile media include, for example, optical or magnetic disks, such as storage device 510. Volatile media include dynamic memory, such as main memory 506. As used herein, tangible media may include volatile and non-volatile media. Common forms of computer-readable media include, for example, floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read. The instructions may optionally be stored on storage device 510 either before or after execution by processor 504.

The computer system 500 also includes a communication interface 512 coupled to bus 502, for providing a two-way data communication coupling computer system 500 to communication link 514. Communication link 514 typically provides data communication to other networks or devices. Although the illustrated example has one communication interface 512 and one communication link 514, those skilled in the art should readily appreciate that this is for ease of illustration, as the example embodiments described herein may have any physically realizable number of communication interfaces 512, and/or communication links 514. The computer system 500 may further include at least one input/output interface 516 connected to the bus 502 and in data communication with one or more user interface devices, such as a mouse, keyboard, monitor/screen, etc. (not explicitly shown).

Notably, while the illustrative embodiment described below shows a single computer system as performing the functions described herein, it is understood that the computer system 500 may comprise, either as a single computer system or as a collection of computer systems, one or more memories, one or more processors, and one or more network interfaces etc., as may be appreciated by those skilled in the art.

The computer system 500 is operable to control the operation of the carton marking system as well as the carton closing system. The computer system 500 is also operable to receive and/or generate data files for producing or generating movement of the marking device to produce the desired markings. The computer system 500 is operable to control various parameters of the marking device, enabling optimization of the performance the marking device which enhances the marking process.

The computer system 500 is preferably interconnected with other computer systems, sensors devices, and other devices associated with other machines, systems, networks, and the like that interact with the carton marking system 300 as set forth in FIGS. 3-4. For example, the computer system 500 is preferably interconnected with the computer system that controls and monitors the operation of an associated the egg-handling machine and an associated egg marking apparatus. The computer system also preferably receives information from position sensors which monitor the operating status of all important moving components of the carton marking system 300.

In one embodiment, the environmental information, product information, positional information, and other relevant processing information may be obtained using image capturing devices, machine-readable or human-readable sensors and identifiers, radio frequency identification transponders (RFID) or other transmitting sensors, time stamps or biometric identification, object recognition, texture definition, database management, and other software, data interface equipment consisting of serial, parallel, or network communication, binary data such as switches, gates, push buttons, current sensors, as well as additional forms of data input. The computer system 500 processes the obtained data and uses such data in the control and operation of the carton marking system as well as the carton closing system.

As discussed above, the computer system 500 is operable to control the operation of the marking assembly. The computer system 500 is also operable to receive and/or generate data files for producing or generating movement of the marking device to produce the desired markings. In particular, the computer system 500 is operable to control the marking assembly to produce text, graphics, images, advertisements or other promotional material, freshness information, traceability data, other types of indicia, and any combination thereof to be marked on the food product packaging.

In addition, the computer system 500 controls the environmental and processing conditions associated with the marking process to optimize the quality and integrity of the markings to be applied thereon. For example, the computer system 500 may control the speed of the cartons passing through the carton marking system to ensure that the markings applied are of consistent quality.

The computer system 500 receives and/or generates the data files for producing the text and/or graphics on the egg cartons via any suitable means. In one embodiment, the computer system 500 generates the data files based on content, image data, and/or other information (“content information”) received from an associated user, other computer system, device, network, or the like. In a preferred embodiment, the computer system includes a content information receiving component 520, which is any suitable software that enables the computer system 500 to receive content information.

In a preferred embodiment, the computer system 500 further includes a content information rendering component 522, which is any suitable software that enables the computer system to render and/or format content information to be applied to the food products. It is to be understood that the content information rendering component 522 suitably renders, formats, or otherwise modifies the received content information to be suitable for marking onto the food products. As used herein, the phrase “render” may be used to describe such rendering, formatting, or modification of the content.

It is to be understood that content information receiving component 520 and content information rendering component 522 may suitably be implemented as logic operable to be executed by processor 504. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (“ASIC”), system on a chip (“SoC”), programmable system on a chip (“PSOC”), a programmable/programmed logic device, memory device containing instructions, or the like, or combinational logic embodied in hardware. Logic may also be fully embodied as software stored on a non-transitory, tangible medium which performs a described function when executed by a processor. Logic may suitably comprise one or more modules configured to perform one or more functions.

In a preferred embodiment, the computer system 500 receives the content information from an associated user, other computer system, device, network, or the like via the content information receiving component 520. Content information may be provided to the computer system through the input/output interface 516 via a suitable user interface device, through the communication interface 512 via the communication link 514, via a computer readable medium, or combinations thereof.

In one embodiment, the content information receiving component 520 may include the functionality to allow an associated user to select parameters, features or other options for the rendering of the content information provided (“rendering options”). For example, the user may be able to select parameters related to text which is to be rendered (Le., font size, font type, font color, resolution, complexity, spacing, placement, etc.); and/or images which are to be rendered (i.e., image size, image type, image color, image resolution, image complexity, spacing, placement smoothing operations, etc.). The user may also be able to select parameters related to marking performance parameters, such as power, spot size, spot area, printing speed, number of passes, frequency, and the like. The user may further be able to select parameters associated with the cartons to which the content information is to be applied, such as specific egg carton(s) on which the information is to be applied, and the like. The rendering option data is then associated with the content information and used in the marking of the content information on the egg cartons.

In some embodiments, the content information receiving component 520 may include the functionality to allow the user to review, verify, and/or approve the content information provided, as well as the selected rendering options prior to or upon submission of the content information. In a preferred embodiment, the user is able to modify or change the content information provided and/or the selected rendering options as desired. The content information provided and/or the selected rendering options may be stored in memory for future use. The content information and rendering options may be stored in memory local to the egg processing facility and/or remotely by any suitable means, and may be accessed and analyzed via any suitable means, such as statistical analysis, to determine any variations, trends, patterns, and the like.

While reference to content information being provided from a user for rendering onto a food product packaging, it is to be understood that content information may be provided from multiple users, and the content information from each of the users may be rendered and applied to the food product packaging. For example, an egg carton may have a marking applied thereon containing content information that is different from other egg cartons in the same batch. Further, an egg carton may have multiple markings applied thereon, wherein the content information for each marking is not provided from the same user.

The content information provided to the content information receiving component 520 is transmitted to the content information rendering component 522 to be rendered in accordance with the selected rendering options for applying such content information to the food product. The content information is formatted, modified, or otherwise changed suitable for marking of the information on the food product. The formatting or changing thereof is preferably based on the characteristics of the text and/or images to be rendered, the printing performance parameters, the food product packaging characteristics, the environmental and processing conditions, and any combination thereof.

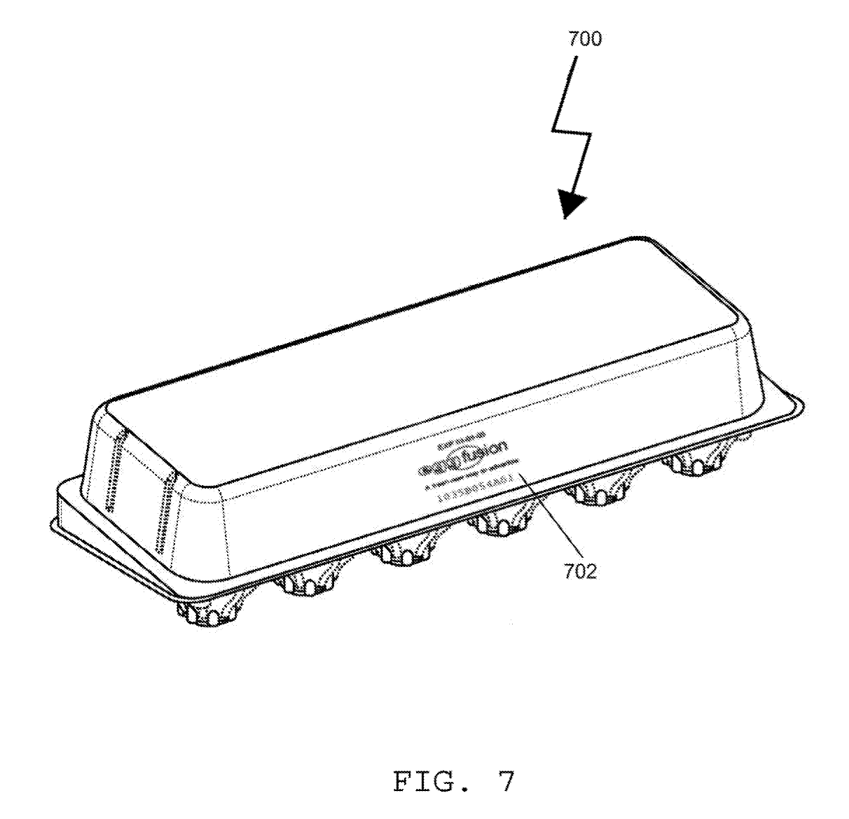

FIG. 6 is a diagram illustrating an egg carton 600 having indicia marked thereon 602 in accordance with the present disclosure. The information marked thereon may include text, graphics, images, other types of indicia, and any combination thereof, and can include an advertisement or other promotional information, freshness information, traceability data, or other types of relevant information.

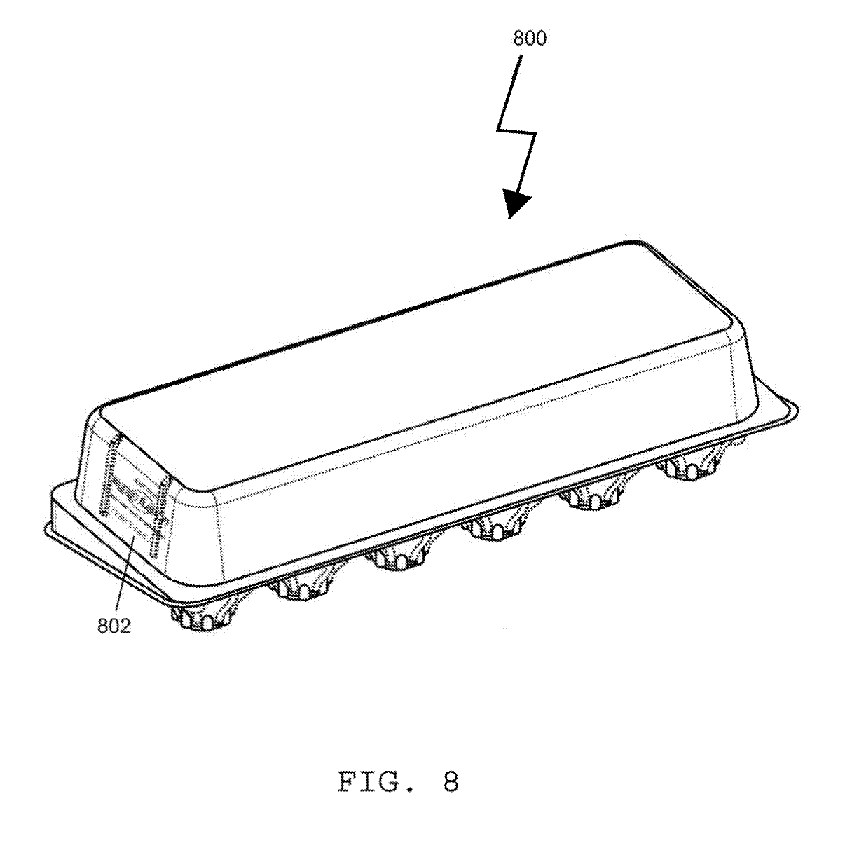

FIG. 7 is a diagram illustrating an egg carton 700 having indicia marked thereon 702 in accordance with the present disclosure. The information marked thereon may include text, graphics, images, other types of indicia, and any combination thereof, and can include an advertisement or other promotional information, freshness information, traceability data, or other types of relevant information.

FIG. 8 is a diagram illustrating an egg carton 800 having indicia marked thereon 802 in accordance with the present disclosure. The information marked thereon may include text, graphics, images, other types of indicia, and any combination thereof, and can include an advertisement or other promotional information, freshness information, traceability data, or other types of relevant information.

Having thus described certain embodiments of systems and methods for practicing aspects of the present disclosure, it is to be appreciated that various alterations, modifications, and improvements will readily occur to those skilled in the art. Such alterations, modifications, and improvements are intended to be part of this disclosure, and are intended to be within the spirit and scope of this disclosure

1. A system for marking food product packages with selected content at a marking station while the objects travel along at least one path through a processing system, the system comprising:
at least one processor operable to control marking of food product packages;
at least one marking unit operatively coupled to the at least one processor and controlled in part by the at least one processor, the at least one marking unit positioned adjacent at least one path along which the food product packages are conveyed, the at least one marking unit operable to mark the food product packages as the food product packages pass through the marking station;
a non-transient memory operatively coupled to the at least one processor and operable to store data associated with the marking of the food product packages;
at least one input/output interface operatively coupled to the processor;
wherein the least one processor is operable to:
determine whether the food product package has been closed;
obtain content marking parameters comprising at least one of content to be marked thereon, at least one rendering parameter associated with marking of the content thereon, at least one characteristic of the food product packages to be marked, and combinations thereof;
render the selected content in accordance with at least a portion of the content marking parameters; and
mark the food product packages with the selected content by the at least one marking unit in accordance with at least a portion of the content marking parameters.

2. The system of claim 1, further comprising at least one food product package closing unit operatively coupled to the at least one processor and controlled in part by the at least one processor, the at least one food package closing unit positioned adjacent at least one path along which the food product packages are conveyed and upstream of the at least one marking unit, the at least one food product package closing unit operable to close open food product packages as the food product packages pass thereby.

3. The system of claim 1, wherein the content to be marked on the food product packages comprises at least one of text, graphics, and any combination thereof, and includes at least one of advertisement, sponsored images, freshness information, traceability data, source information, and any combination thereof.

4. The system of claim 1, wherein the at least one rendering parameter comprises at least one of at least one parameter associated with text, graphics, images, and combinations included in the content, at least one operational parameter of the at least one marking unit, at least one parameter associated with the food product packages which are to be marked, and combinations thereof.

5. The system of 1, wherein the at least one processor is further operable to receive at least a portion of the content marking parameters from at least one associated user via the at least one input/output interface.

6. The system of claim 1, wherein the at least one processor is further operable to:
receive at least a portion of the content marking parameters from multiple associated users via the at least one input/output interface;
generate aggregate content marking parameters based on the content marking parameters received from at least a portion of the multiple users;
render the selected content in accordance with at least a portion of the aggregate content marking parameters; and
mark the food product packages with the selected content by the at least one marking unit in accordance with at least a portion of the aggregate content marking parameters.

7. The system of claim 2, wherein the food product packages are egg cartons and the food product package closing unit is an egg carton lid closing unit having a progressive closing action mechanism.

8. The system of claim 7, wherein the marking station comprises at least two parallel-motion rails positioned on opposite sides of at least one path along which the egg cartons are conveyed and are operable to provide consistent pressure on the sides of the egg cartons to orient the egg cartons with respect to the at least one marking unit for marking thereon.

9. The system of claim 7, wherein the at least two parallel-motion rails are operable to adjust in order to provide consistent pressure on the sides of the eggs cartons of differing types, differing dimensions, and combinations thereof.

10. A method for marking food product packages with selected content at a marking station while the objects travel along at least one path through a processing system, wherein at least one marking unit is positioned adjacent at least one path along which the food product packages are conveyed, the at least one marking unit operable to mark the food product packages as the food product packages pass through the marking station, the method comprising:
determining whether the food product package has been closed;
obtaining content marking parameters comprising at least one of content to be marked thereon, at least one rendering parameter associated with marking of the content thereon, at least one characteristic of the food product packages to be marked, and combinations thereof;
rendering the selected content in accordance with at least a portion of the content marking parameters; and
marking the food product packages with the selected content by the at least one marking unit in accordance with at least a portion of the content marking parameters.

11. The method of claim 10, wherein the content to be marked on the food product packages comprises at least one of text, graphics, and any combination thereof, and includes at least one of advertisement, sponsored images, freshness information, traceability data, source information, and any combination thereof.

12. The method of claim 10, wherein the at least one rendering parameter comprises at least one of at least one parameter associated with text, graphics, images, and combinations included in the content, at least one operational parameter of the at least one marking unit, at least one parameter associated with the food product packages which are to be marked, and combinations thereof.

13. The method of 10, wherein the method further comprises receiving at least a portion of the content marking parameters from at least one associated user via at least one input/output interface.

14. The method of claim 10, wherein the method further comprising:
receiving at least a portion of the content marking parameters from multiple associated users via the at least one input/output interface;
generating aggregate content marking parameters based on the content marking parameters received from at least a portion of the multiple users;
rendering the selected content in accordance with at least a portion of the aggregate content marking parameters; and
marking the food product packages with the selected content by the at least one marking unit in accordance with at least a portion of the aggregate content marking parameters.

15. The method of claim 10, wherein the food product packages are egg cartons.

16. The method of claim 15, wherein the food product package is closed via a progressive closing action.

17. The method of claim 15, wherein the method further comprises applying consistent pressure on the sides of the egg cartons by at least two parallel-motion rails positioned on opposite sides of at least on path along which the egg cartons are conveyed to orient the egg cartons with respect to the at least one marking unit for marking thereon.

18. The method of claim 17, wherein the method further comprises adjusting the at least two parallel-motion rails in order to provide consistent pressure on the sides of the eggs cartons of differing types, differing dimensions, and combinations thereof.

19. An apparatus for ink marking food product packages with selected content at a marking station, the system comprising:
at least one processor operable to control marking of food product packages;
at least one ink marking unit operatively coupled to the at least one processor and controlled in part by the at least one processor, the at least one ink marking unit positioned above at least one path along which the food product packages are conveyed, the at least one ink marking unit operable to mark the food product packages as the food product packages pass thereunder and through the marking station; and
a non-transient memory operatively coupled to the at least one processor and operable to store data associated with the marking of the food product packages;
wherein the least one processor is operable to:
determine whether the food product package has been closed;
obtain content marking parameters comprising at least one of content to be marked thereon, at least one rendering parameter associated with marking of the content thereon, at least one characteristic of the food product packages to be marked, and combinations thereof;
render the selected content in accordance with at least a portion of the content marking parameters; and
mark the food product packages with the selected content by the at least one ink marking unit in accordance with at least a portion of the content marking parameters.

20. The apparatus of claim 19, further comprising at least one food product package closing unit operatively coupled to the at least one processor and controlled in part by the at least one processor, the at least one food package closing unit positioned adjacent at least one path along which the food product packages are conveyed and upstream of the at least one ink marking unit, the at least one food product package closing unit operable to close open food product packages as the food product packages pass thereby.
